(19) United States
(12) Patent Application Publication
(10) Pub. No.: US 2005/0255998 A1
(43) Pub. Date: Nov. 17, 2005

(54) Mixture of colour developers

(76) Inventor: James Philip Taylor, Springhead (GB)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/506,137

(22) PCT Filed: Feb. 25, 2003
(86) PCT No.: PCT/EP03/01897

§ 371 Date: Aug. 26, 2004

(30) Foreign Application Priority Data
Mar. 6, 2002 (EP) 02405172.4

(51) Int. Cl. B41M 5/20; B41M 5/24

(52) U.S. Cl. 503/216

(57) ABSTRACT

Mixture of colour developers comprising a compound of the formula (I) and a compound of formula (II), wherein R¹ is C₁-C₂₀alkyl or C₆-C₁₀aryl, which can be substituted one to three times with halogen, C₁-C₄alkyl, —NR²R³, wherein R² and R³ independently from each other stand for hydrogen or C₁-C₈alkyl, or C₁-C₈acyl amino, a heat sensitive recording and the use of the inventive mixture for the manufacture of a heat-sensitive colored image-forming layer for the manufacture of heat-sensitive recording material.

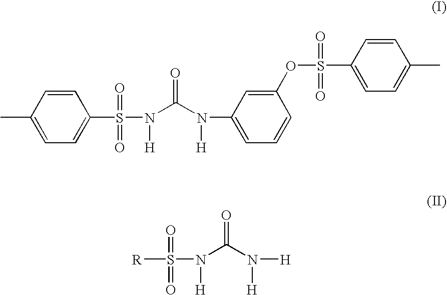

The present invention relates to a mixture of colour developers comprising a compound of the formula I 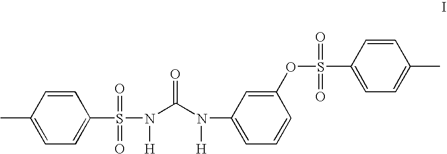
and a compound of formula II 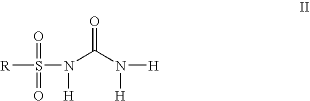
wherein
R¹ is C₁-C₂₀alkyl or C₆-C₁₀aryl, which can be substituted one to three times with halogen, C₁-C₄alkyl, —NR²R³, wherein R² and R³ independently from each other stand for hydrogen or C₁-C₈alkyl, or C₁-C₈acyl amino, and their use in heat sensitive compositions.

Compound I is disclosed in EP-A 1,140,515. Though this compound exhibits excellent properties with regard to resistance to plasticiser, oil and heat ageing and a very good background whiteness, still a need exists to even further improve background whiteness, in particular after ageing at elevated temperature in a humid atmosphere, and to improve image whilst showing at least equal properties with regard to initial image density and resistance to oil compared to compound I.

Accordingly, the claimed composition has been found. In addition, a heat sensitive recording material has been found, too, as well as the use of the claimed mixture in heat sensitive recording materials.

Compounds I and II are commercially available or can be synthesized according to known methods (see e.g. EP-A 1,140,515).

In a preferred embodiment of this invention the weight ratio of compounds I and II are chosen in the range of from 999:1 to 1:1, preferably from 999:1 to 3:1.

C₁-C₂₀alkyl stands for branched or unbranched C₁-C₂₀alkyl such as e.g. for methyl, ethyl, n-, i-propyl, n-, i-, sec.-, tert.-butyl, n-pentyl, n-hexyl, n-heptyl, n-octyl, 2-ethylhexyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, preferably for C₁-C₈alkyl such as methyl, ethyl, n-, i-propyl, n-, i-, sec.-, tert.-butyl, n-pentyl, n-hexyl, n-heptyl, n-octyl, 2-ethylhexyl, more preferably for C₁-C₄alkyl such as methyl, ethyl, n-, i-propyl, n-, i-, sec.-, tert.-butyl.

C₁-C₈acyl amino stands for —NH—C(═O)—C₁-C₈alkyl, preferably for —NH—C(═O)—CH₃, —NH—C(═O)—C₂H₅, —NH—C(═O)-n-Pr, —NH—C(═O)-i-Pr, —NH—C(═O)-n-Bu, —NH—C(═O)-i-Bu, —NH-C(═O)-sec.-Bu, or —NH—C(═O)-tert.-Bu.

C₆-C₁₀aryl stands for phenyl or naphthyl. Preferred substituted C₆-C₁₀aryl groups are tolyl, xylenyl, anisoyl.

Halogen stands for fluorine, chlorine, bromine or iodine, preferably for chlorine, bromine.

In a preferred embodiment —NR²R³ stands for dimethylamino, diethylamino, diphenylamino or dibenzylamino.

In a preferred embodiment R¹stands for hexadecyl, phenyl, 4-methyl phenyl, or naphthyl.

Another preferred embodiment of this invention relates to a heat sensitive recording material comprising:
a) a substrate sheet, and
b) a heat sensitive colored image-forming layer formed on the surface of the substrate sheet and comprising
   b1) a colour former compound
   b2) the inventive mixture of colour developers.

Usually the components b1) and b2) are used in a weight ratio in the range of from 1:1 to 5:1, preferably from 2:1 to 3:1.

As colour former compounds the known colour former compounds can be used, which are, as a rule, based on derivatives of, for example, triphenylmethanes, lactones, benzoxazines, spiropyrans or preferably fluorans.

Preferred colour formers include, but are not limited to: 3-diethylamino-6-methylfluoran, 3-dimethylamino-6-methyl-7-anilinofluoran, 3-diethylamino-6-methyl-7-anilinofluoran, 3-diethylamino-6-methyl-7-(2,4-dimethylanilino) fluoran, 3-diethylamino-6-methyl-7-chlorofluoran, 3-diethylamino-6-methyl-7-(3-trifluoromethylanilino) fluoran, 3-diethylamino-6-methyl-7-(2-chloroanilino) fluoran, 3-diethylamino-6-methyl-7-(4-chloroanilino) fluoran, 3-diethylamino-6-methyl-7-(2-fluoroanilino) fluoran, 3-diethylamino-6-methyl-7-(4-n-octylanilino) fluoran, 3-diethylamino-7-(4-n-octylanilino) fluoran, 3-diethylamino-7-(n-octylamino) fluoran, 3-diethylamino-7-(dibenzylamino) fluoran, 3-diethylamino-6-methyl-7-(dibenzylamino) fluoran, 3-diethylamino-6-chloro-7-methylfluoran, 3-diethylamino-7-t-butylfluoran, 3-diethylamino-7-carboxyethylfluoran, 3-diethylamino-6-chloro-7-anilinofluoran, 3-diethylamino-6-methyl-7-(3-methylanilino) fluoran, 3-diethylamino-6-methyl-7-(4-methylanilino) fluoran, 3-diethylamino-6-ethoxyethyl-7-anilinofluoran, 3-diethylamino-7-methylfluoran, 3-diethylamino-7-chlorofluoran, 3-diethylamino-7-(3-trifluoromethylanilino) fluoran, 3-diethylamino-7-(2-chloroanilino) fluoran, 3-diethylamino-7-(2-fluoroanilino) fluoran, 3-diethylamino-benzo[a] fluoran, 3-diethylamino-benzo[c] fluoran, 3-dibutylamino-7-dibenzylaminofluoran , 3-dibutylamino-7-anilinofluoran, 3-diethylamino-7-anilinofluoran, 3-dibutylamino-6-methyl fluoran, 3-dibutylamino-6-methyl-7-anilinofluoran, 3-dibutylamino-6-methyl-7-(2,4-dimethylanilino) fluoran, 3-dibutylamino-6-methyl-7-(2-chloroanilino) fluoran, 3-dibutylamino-6-methyl-7-(4-chloroanilino) fluoran, 3-dibutylamino-6-methyl-7-(2-fluoroanilino) fluoran, 3-dibutylamino-6-methyl-7-(3-trifluoromethylanilino) fluoran, 3-dibutylamino-6-ethoxyethyl-7-anilinofluoran, 3-dibutylamino-6-chloro-anilinofluoran, 3-dibutylamino-6-methyl-7-(4-methylanilino) fluoran, 3-dibutylamino-7-(2-chloroanilino) fluoran, 3-dibutylamino-7-(2-fluoroanilino) fluoran, 3-dibutylamino-7-(N-methyl-N-formylamino) fluoran, 3-dipentylamino-6-methyl-7-anilinofluoran, 3-dipentylamino-6-methyl-7-(4-2-chloroanilino) fluoran, 3-dipentylamino-7-(3-trifluoromethylanilino) fluoran, 3-dipentylamino-6-chloro-7-anilinofluoran, 3-dipentylamino-7-(4-chloroanilino) fluoran, 3-pyrrolidino-6-methyl-7-anilinofluoran, 3-piperidino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-cyclohexylamino)-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-(N-ethyl-N-isoamylamino)-6-chloro-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-(N-butyl-N-isoamylamino)-6-methyl-7-anilinofluoran, 3-(N-isopropyl-N-3-pentylamino)-6-methyl-7-anilinofluoran, 3-(N-ethyl-N-ethoxypropylamino)-6-methyl-7-anilinofluoran, 3-cyclohexylamino-6-chlorofluoran, 2-methyl-6-p-(p-dimethylaminophenyl)aminoanilinofluoran, 2-methoxy-6-p-(p-dimethylaminophenyl)aminoanilinofluoran, 2-chloro-3-methyl-6-p-(p-phenylamino-phenyl)aminoanilinofluoran, 2-diethylamino-6-p-(p-dimethylaminophenyl)-amino-anilinofluoran, 2-phenyl-6-methyl--6-p-(p-phenylaminophenyl)aminoanilinofluoran, 2-benzyl-6-p-(p-phenylaminophenyl)aminoanilinofluoran, 3-methyl-6-p-(p-dimethyl-aminophenyl)aminoanilinofluoran, 3-diethylamino-6-p-(p-diethylaminophenyl)-aminoanilinofluoran, 3-diethylamino-6-p-(p-dibutylaminophenyl)aminoanilino-fluoran, 2,4-dimethyl-6-[(4-dimethylamino)anilino] fluoran, 3-[(4-dimethylamino-phenyl)amino]-5,7-dimethylfluoran, 3,6,6′-tris(dimethylamino)spiro[fluorene-9,3′-phthalide], 3,6,6′-tris(diethylamino)spiro[fluorene-9,3′-phthalide], 3,3-bis(p-dimethylaminophenyl)-6-dimethylaminophthalide, 3,3-bis(p-dimethylamino-phenyl)phthalide, 3,3-bis-[2-(p-dimethylaminophenyl)-2-(p-methoxyphenyl)ethenyl-4,5,6,7-tetrabromophthalide, 3,3-bis-[2-(p-dimethylaminophenyl)-2-(p-methoxy-phenyl)ethenyl-4,5,6,7-tetrachlorophthalide, 3,3-bis[1,1-bis(4-pyrrolidinophenyl)-ethylene-2-yl]-4,5,6,7-tetrabromophthalide, 3,3-bis-[1-(4-methoxyphenyl)-1-(4-pyrridinophenyl)ethylene-2-yl]-4,5,6,7-tetrachlorophthalide, 3-(4-diethylamino-2-ethoxyphenyl)-3-(1-ethyl-2-methylindole-3-yl)-4-azaphthalide, 3-(4-diethylamino-2-ethoxyphenyl)-3-(1-octyl-2-methylindole-3-yl)4-azaphthalide, 3-(4-cyclohexyl-ethylamino-2-methoxyphenyl)-3-(1-ethyl-2-methylindole-3-yl)-4-azaphthalide, 3,3-bis(1-ethyl-2-methylindole-3-yl) phthalide, 3,3-bis(1-octyl-2-methylindole-3-yl) phthalide, mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine, 4,4′-[1-methyl-ethylidene)bis(4,1-phenyleneoxy-4,2-quinazolinediyl)]bis[N,N-diethylbenzenamine], bis(N-methyldiphenylamine)-4-yl-(N-butylcarbazole)-3-yl-methane and mixtures thereof.

All of the above colour forming compounds can be used singly or as a mixture with other colour forming compounds, or they may also be used together with further black colour forming compounds.

Highly preferred are 3-diethylamino-6-methyl-7-anilinofluoran, 3-diethylamino-6-methyl-7-(3-methylanilino) fluoran, 3-diethylamino-6-methyl-7-(2,4-dimethylanilino) fluoran, 3-dibutylamino-6-methyl-7-anilinofluoran, 3-dipentylamino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-isoamylamino)-6-methyl-7-anilinofluoran, 3-diethylamino-6-chloro-7-anilinofluoran, 3-dibutylamino-7-(2-chloroanilino)fluoran, 3-N-ethyl-p-toluidino-6-methyl-7-anilinofluoran, 3-(N-ethyl-N-tetrahydrofurfurylamino)-6-methyl-7-anilinofluoran, 3-(N-ethyl-N-isobutylamino)-6-methyl-7-anilinofluoran, 3-N-ethyl-N-ethoxypropylamino-6-methyl-7-anilino-fluoran, 2,4-dimethyl-6-[(4-dimethylamino)anilino]fluoran, 3-(4-diethylamino-2-ethoxyphenyl)-3-(1-octyl-2-methylindole-3yl)4-azaphthalide, 3,3-bis(p-dimethyl-aminophenyl)-6-dimethylaminophthalide and mixtures thereof.

It is also possible to use solid solutions comprising at least two colour forming compounds.

A monophase (or single-phase or guest-host) solid solution possesses a crystal lattice which is identical with the crystal lattice of one of its components. One component is embedded as the ‘guest’ in the crystal lattice of the other component, which acts as the ‘host’. The X-ray diffraction pattern of such a monophase solid solution is substantially identical to that of one of the components, called the ‘host’. Within certain limits, different proportions of the components produce almost identical results.

The term ‘monophase solid solution’ or ‘multiphase solid solution’ or mixed crystal’, as defined herein, therefore, should be taken from the following definitions, which have been adapted to the current improved state of knowledge of such systems: A monophase (or single-phase or guest-host) solid solution possesses a crystal lattice which is identical with the crystal lattice of one of its components. One component is embedded as the ‘guest’ in the crystal lattice of the other component, which acts as the ‘host’. The X-ray diffraction pattern of such a monophase solid solution is substantially identical to that of one of the components, called the ‘host’. Within certain limits, different proportions of the components produce almost identical results.

A multiphase solid solution possesses no precise, uniform crystal lattice. It differs from a physical mixture of its components in that the crystal lattice of at least one of its components is partially or completely altered. In comparison to a physical mixture of the components, which gives an X-ray diffraction diagram that is additive of the diagrams seen for the individual components. The signals in the X-ray diffraction diagram of a multiphase solid solution are broadened, shifted or altered in intensity. In general, different proportions of the components produce different results.

A mixed crystal (or solid compound type) solid solution possesses a precise composition and a uniform crystal lattice, which is different from the crystal lattices of all its components. If different proportions of the components lead, within certain limits, to the same result, then a solid solution is present in which the mixed crystal acts as a host.

For the avoidance of doubt it may also be pointed out that, inter alia, there may also be amorphous structures and mixed aggregates consisting of different particles of different physical type, such as, for example, an aggregate of different components each in pure crystal modification. Such amorphous structures and mixed aggregates cannot be equated with either solid solutions or mixed crystals, and possess different fundamental properties.

As hereinbefore detailed, the monophase solid solutions comprise a plurality of colour compounds. Suitable colour forming materials, which may be included in the solid solutions are those given above.

Of particular interest are the following monophase solid solutions: 3-dibutylamino-6-methyl-7-anilinofluoran and 3-dibutylamino-7-dibenzylamino-fluoran; 3-dibutylamino-6-methyl-7-anilinofluoran and 3-dibutylamino-7-anilinofluoran; 3-dibutylamino-6-methyl-7-anilinofluoran and 3-diethylamino-7-anilinofluoran; 3-diethylamino-6-methyl-7-anilinofluoran and 3-diethylamino-7-anilinofluoran; 3-dibutylamino-6-methyl-7-anilinofluoran and 3-diethylamino-6-methyl-7-anilinofluoran; 3-dibutylamino-6-methyl-7-anilinofluoran and 3-N-isoamyl-N-ethylamino-6-methyl-7-anilinofluoran; 3-dibutylamino-6-methyl-7-anilinofluoran and 3-N-2-pentyl-N-ethylamino-6-methyl-7-anilinofluoran; 3-dibutylamino-6-methyl-7-anilinofluoran and 3-N-isopropyl-N-ethylamino-6-methyl-7-anilinofluoran; 3-dibutylamino-6-methyl-7-anilinofluoran and 3-N-Cyclohexylmethyl-N-ethylamino-6-methyl-7-anilinofluoran; 3-dibutylamino-6-methyl-7-anilinofluoran and 3-dipropylamino-6-methyl-7-anilinofluoran; 3-dibutylamino-6-methyl-7-anilinofluoran and 3-N-2-butyl-N-ethylamino-6-methyl-7-anilinofluoran; 3-dibutylamino-6-methyl-7-anilinofluoran and 3-N-cyclohexyl-N-methylamino-6-methyl-7-anilinofluoran; 3-dibutylamino-6-methyl-7-anilinofluoran and 3-diethylamino-6-methyl-7-(3-methyl-anilino) fluoran; 3-dibutylamino-6-methyl-7-anilinofluoran and 3-diethylamino-6-methyl-7-(2,4-dimethylanilino) fluoran; 3-dibutylamino-6-methyl-7-anilinofluoran and 3-dipentylamino-6-methyl-7-anilinofluoran; 3-dibutylamino-6-methyl-7-anilinofluoran and 3-(N-methyl-N-propylamino)-6-methyl-7-anilinofluoran; 3-dibutylamino-6-methyl-7-anilinofluoran and 3-diethylamino-6-chloro-7-anilino-fluoran; 3-dibutylamino-6-methyl-7-anilinofluoran and 3-dibutylamino-7-(2-chloroanilino)fluoran; 3-dibutylamino-6-methyl-7-anilinofluoran and 3-N-ethyl-p-toluidino-6-methyl-7-anilinofluoran; 3-dibutylamino-6-methyl-7-anilinofluoran and 3-(N-ethyl-N-tetrahydrofurfurylamino)-6-methyl-7-anilinofluoran; 3-dibutylamino-6-methyl-7-anilinofluoran and 3-(N-ethyl-N-isobutylamino)-6-methyl-7-anilinofluoran; 3-dibutylamino-6-methyl-7-anilinofluoran and 3-N-ethyl-N-ethoxypropylamino-6-methyl-7-anilinofluoran; 3-dibutylamino-6-methyl-7-anilinofluoran and 2,4-dimethyl-6-[(4-dimethylamino)anilino]fluoran; 3-N-isoamyl-N-ethylamino-6-methyl-7-anilinofluoran and 3-diethylamino-6-methyl-7-anilinofluoran; 3-diethylamino-6-methyl-7-anilinofluoran and 3-N-propyl-N-methylamino-6-methyl-7-anilinofluoran; 3-diethylamino-6-methyl-7-(3-tolyl)aminofluoran and 3-diethylamino-6-methyl-7-anilinofluoran; 3-dibutylamino-6-methyl-7-anilinofluoran and 3,3-bis(1-octyl-2-methylindol-3-yl)phthalide; 3-dibutylamino-6-methyl-7-anilinofluoran and mixture of 2-phenyl-4-(4-diethylaminophenyl)-4-(4-methoxyphenyl)-6-methyl-7-dimethyl-amino-3,1-benzoxazine and 2-phenyl-4-(4-diethylaminophenyl)-4-(4-methoxy-phenyl)-8-methyl-7-dimethylamino-3,1-benzoxazine; 3-dibutylamino-6-methyl-7-anilinofluoran and 4,4′-[1-methylethylidene)bis(4,1-phenyleneoxy-4,2-quinazoline-diyl)]bis[N,N-diethylbenzenamine].

Usually in the above monophase solid solutions the first compound is in a molar ratio of 75 to 99.9% by mole, the second compound is in a ratio of 25 to 0.1% by mole.

Examples of monophase solid solutions comprising two components in the stated ratios are: 3-dibutylamino-6-methyl-7-anilinofluoran (99.9%), 3-diethylamino-6-methyl-7-anilinofluoran (0.1%); 3-dibutylamino-6-methyl-7-anilinofluoran (99%), 3-diethylamino-6-methyl-7-anilinofluoran (1%); 3-dibutylamino-6-methyl-7-anilino-fluoran (95%), 3-diethylamino-6-methyl-7-anilinofluoran (5%); 3-dibutyl-amino-6-methyl-7-anilinofluoran (90%) and 3-N-2-pentyl-N-ethylamino-6-methyl-7-anilino-fluoran (10%); 3-dibutylamino-6-methyl-7-anilinofluoran (95%) and 3-N-2-pentyl-N-ethylamino-6-methyl-7-anilinofluoran (5%); 3-dibutylamino-6-methyl-7-anilino-fluoran (90%) and 3-N-isopropyl-N-ethylamino-6-methyl-7-anilinofluoran (10%); 3-dibutylamino-6-methyl-7-anilinofluoran (95%) and 3-N-isopropyl-N-ethylamino-6-methyl-7-anilinofluoran (5%); 3-dibutylamino-6-methyl-7-anilinofluoran (90%) and 3-N-Cyclohexylmethyl-N-ethylamino-6-methyl-7-anilinofluoran (10%); 3-dibutyl-amino-6-methyl-7-anilinofluoran (95%) and 3-N-Cyclohexylmethyl-N-ethylamino-6-methyl-7-anilinofluoran (5%); 3-dibutylamino-6-methyl-7-anilinofluoran (90%) and 3-dipropylamino-6-methyl-7-anilinofluoran (10%); 3-dibutylamino-6-methyl-7-anilinofluoran (95%) and 3-dipropylamino-6-methyl-7-anilinofluoran (5%); 3-dibutylamino-6-methyl-7-anilinofluoran (90%) and 3-N-2-butyl-N-ethylamino-6-methyl-7-anilinofluoran (10%); 3-dibutylamino-6-methyl-7-anilinofluoran (95%) and 3-N-2-butyl-N-ethylamino-6-methyl-7-anilinofluoran (5%); 3-dibutylamino-6-methyl-7-anilinofluoran (90%), 3-diethylamino-6-methyl-7-anilinofluoran (10%); 3-dibutylamino-6-methyl-7-anilinofluoran (85%), 3-diethylamino-6-methyl-7-anilinofluoran (15%); 3-dibutylamino-6-methyl-7-anilinofluoran (80%), 3-diethylamino-6-methyl-7-anilinofluoran (20%); 3-dibutylamino-6-methyl-7-anilinofluoran (95%), 3-N-isoamyl-N-ethylamino-6-methyl-7-anilinofluoran (5%); 3-dibutylamino-6-methyl-7-anilinofluoran (90%), 3-N-isoamyl-N-ethylamino-6-methyl-7-anilinofluoran (10%); 3-dibutylamino-6-methyl-7-anilinofluoran (80%), 3-N-isoamyl-N-ethylamino-6-methyl-7-anilinofluoran (20%); 3-dibutylamino-6-methyl-7-anilinofluoran (90%), 3-N-cyclohexyl-N-methylamino-6-methyl-7-anilinofluoran (10%); 3-diethylamino-6-methyl-7-anilinofluoran (90%), 3-N-isoamyl-N-ethylamino-6-methyl-7-anilinofluoran (10%); 3-diethylamino-6-methyl-7-anilinofluoran (80%), 3-N-isoamyl-N-ethylamino-6-methyl-7-anilinofluoran (20%); 3-diethylamino-6-methyl-7-anilinofluoran (20%), 3-N-isoamyl-N-ethylamino-6-methyl-7-anilinofluoran (80%); 3-diethylamino-6-methyl-7-anilinofluoran (10%), 3-N-isoamyl-N-ethylamino-6-methyl-7-anilinofluoran (90%); 3-diethylamino-6-methyl-7-anilinofluoran (90%), 3-N-propyl-N-methylamino-6-methyl-7-anilinofluoran (10%); 3-diethylamino-6-methyl-7-anilinofluoran (80%), 3-N-propyl-N-methylamino-6-methyl-7-anilinofluoran (20%); 3-diethylamino-6-methyl-7-anilinofluoran (20%), 3-N-propyl-N-methylamino-6-methyl-7-anilinofluoran (80%); 3-diethylamino-6-methyl-7-anilinofluoran (10%), 3-N-propyl-N-methylamino-6-methyl-7-anilinofluoran (90%); 3-diethylamino-6-methyl-7-anilinofluoran (10%), 3-diethylamino-6-methyl-7-(3-tolyl)aminofluoran (90%); 3-diethylamino-6-methyl-7-anilinofluoran (20%), 3-diethylamino-6-methyl-7-(3-tolyl)aminofluoran (80%); 3-dibutylamino-6-methyl-7-anilinofluoran (90%), 3,3-bis(1-octyl-2-methylindol-3-yl)phthalide (10%); 3-dibutylamino-6-methyl-7-anilinofluoran (80%), 3,3-bis(1-octyl-2-methylindol-3-yl)phthalide(20%); 3-dibutylamino-6-methyl-7-anilinofluoran (90%), mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine(10%); 3-dibutylamino-6-methyl-7-anilinofluoran (80%), mixture of 2-phenyl-4-(4-diethylaminophenyl)-4-(4-methoxyphenyl)-6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine(20%); 3-dibutylamino-6-methyl-7-anilinofluoran (90%), 4,4′-[1-methylethylidene)bis(4,1-phenyleneoxy-4,2-quinazolinediyl)]bis[N,N-diethylbenzenamine](10%); 3-dibutylamino-6-methyl-7-anilinofluoran (80%), 4,4′-[1-methylethylidene)bis(4,1-phenyleneoxy-4,2-quinazolinediyl)]bis[N,N-diethylbenzenamine] (20%).

The monophase solid solutions can be used singly or as a mixture with other colour forming compounds such as triphenylmethanes, lactones, fluorans, benzoxazines and spiropyrans; or they may also be used together with further black colour forming compounds. Examples of such other colour forming compounds are given hereinbefore.

The monophase solid solutions can be prepared by a variety of methods. One such method is the recrystallisation method wherein a physical mixture of the desired components is dissolved, with or without heating, in a suitable solvent or solvent mixture. Suitable solvents include but are not limited to toluene, benzene, xylene, dichlorobenzene, chlorobenzene, 1,2-dichloroethane, methanol, ethanol, iso-propanol, n-butanol, acetonitrile, dimethylformamide or mixtures of these solvents with each other and with water. The monophase solid solution is then isolated by crystallisation from the solvent or solvent mixture. This can be brought about by cooling, standing, addition of a further solvent to promote crystallisation or concentration by standard means such as distillation, steam distillation and vacuum distillation. When the monophase solid solution is isolated by concentration it may be advantageous to do so in the presence of a small amount of base, to improve the visual aspect of the isolated product.

Alternatively, monophase solid solutions can be prepared from mixtures of the appropriate starting materials. The technique can be used to produce mixtures of two or more fluorans or phthalides. For example, mixtures of two fluorans are produced by replacing a single starting material with two analogous materials to the same total molar concentration in the reaction. In the case of fluorans, these starting materials are derivatives of amino phenols, phthalic anhydrides, keto acids and diphenylamines.

In addition, the heat sensitive recording material can contain additionally developers, unless the colour forming performance of the resultant heat sensitive material is disturbed thereby. Such developers are exemplified by but not limited to: 4,4′-isopropylidene bisphenol, 4,4′-sec-butylidene bisphenol, 4,4′-cyclohexylidene bisphenol, 2,2-bis-(4-hydroxyphenyl)-4-methylpentane, 2,2-dimethyl-3,3-di(4-hydroxyphenyl)butane, 2,2′-dihydroxydiphenyl, 1-phenyl-1,1-bis(4-hydroxyphenyl)butane, 4-phenyl-2,2-bis(4-hydroxyphenyl)butane, 1-phenyl-2,2-bis(4-hydroxyphenyl)butane, 2,2-bis(4′-hydroxy-3′-methylphenyl)-4-methylpentane, 2,2-bis(4′-hydroxy-3′-tert-butyllphenyl)-4-methylpentane, 4,4′-sec-butylidene-bis (2-methylphenol), 4,4′-isopropylidene-bis (2-tert-butylphenol), 2,2-bis(4′-hydroxy-3′-isopropylphenyl)-4-methylpentane, allyl-4,4-bis (4′-hydroxyphenyl) pentanoate, propargyl-4,4-bis(4′-hydroxyphenyl) pentanoate, n-propyl-4,4-bis (4′-hydroxyphenyl) pentanoate, 2,4-bis (phenylsulfonyl) phenol, 2-(4-methylsulfonyl)-4-(phenylsulfonyl) phenol, 2-(phenylsulfonyl)-4-(4-methylsulfonyl) phenol, 2,4-bis (4-methylphenylsulfonyl) phenol, pentamethylene-bis(4-hydroxybenzoate), 2,2-dimethyl-3,3-di(4-hydroxyphenyl)pentane, 2,2-di(4-hydroxyphenyl)hexane, 4,4′-dihydroxydiphenyl thioether, 1,7-di(4-hydroxyphenylthio)-3,5-dioxaheptane, 2,2′-bis(4-hydroxyphenylthio)diethyl ether, 4,4′-dihydroxy-3,3′-dimethylphenyl thioether; benzyl-4-hydroxybenzoate, ethyl-4-hydroxybenzoate, propyl-4-hydroxybenzoate, isopropyl-4-hydroxybenzoate, butyl-4-hydroxybenzoate, isobutyl-4-hydroxyben-zoate, 4,4′-dihydroxydiphenyl sulfone, 2,4′-dihydroxydiphenyl sulfone, 4-hydroxy-4′-methyldiphenyl sulfone, 4-hydroxy-4′-isopropoxydiphenyl sulfone, 4-hydroxy-4′-butoxydiphenyl sulfone, 4,4′-dihydroxy-3,3′-diallyidiphenyl sulfone, 3,4-dihydroxy-4′-methyidiphenyl sulfone, 4,4′-dihydroxy-3,3′,5,5′-tetrabromodiphenyl sulfone, 4,4′-bis (p-toluenesulphonylaminocarbonylamino) diphenylmethane, N-p-toluene-sulphonyl-N′-phenyl urea, dimethyl 4-hydroxyphthalate, dicyclohexyl 4-hydroxy-phthalate, diphenyl 4-hydroxyphthalate, 4-[2-(4-methoxyphenyloxy)ethyloxy]-salicylate, 3,5-di-tert-butylsalicylic acid, 3-benzyl salicylic acid, 3-(α-methylbenzyl) salicylic acid, 3-phenyl-5-(α,α-dimethylbenzyl) salicylic acid, 3,5-di-α-methylbenzyl salicylic acid; metal salts of salicylic acid, 2-benzylsulfonylbenzoic acid, 3-cyclohexyl-4-hydroxybenzoic acid, zinc benzoate, zinc 4-nitrobenzoate, 4-(4′-phenoxybutoxy)-phthalic acid, 4-(2′-phenoxyethoxy)phthalic acid, 4-(3′-phenylpropyloxy)phthalic acid, mono (2-hydroxyethyl)-5-nitro-isophthalic acid, 5-benzyloxycarbonyl isophthalic acid, 5-(1′-phenylethanesulfonyl) isophthalic acid, bis(1,2-dihydro-1,5-dimethyl-2-phenyl-3H-pyrazol-3-one-O)bis(thiocyanato-N) zinc and mixtures thereof.

The amounts of additionally developers can be chosen in the range of from 1% by weight to 99% by weight, based on the total amount of developers.

In addition, the heat sensitive recording material of the invention can contain a sensitiser. The weight ratio of sensitiser to colour former is usually chosen in the range of from 0.5:1 to 3:1, preferably 1:1 to 2:1, based on the total amount of the heat sensitive recording material.

Representative examples of sensitiser are stearamide, methylol stearamide, p-benzylbiphenyl, m-terphenyl, 2-benzyloxynaphthalene, 4-methoxybiphenyl, dibenzyl oxalate, di(4-methylbenzyl) oxalate, di(4-chlorobenzyl) oxalate, dimethyl phthalate, dibenzyl terephthalate, dibenzyl isophthalate, 1,2-diphenoxyethane, 1,2-bis(4-methylphenoxy) ethane, 1,2-bis(3-methylphenoxy) ethane, 4,4′-dimethylbiphenyl, phenyl-1-hydroxy-2-naphthoate, 4-methylphenyl biphenyl ether, 1,2-bis(3,4-dimethylphenyl) ethane, 2,3,5,6-4′-methyldiphenyl methane, 1,4-diethoxy-naphthalene, 1,4-diacetoxybenzene, 1,4-diproprionoxybenzene, o-xylylene-bis(phenyl ether), 4-(m-methylphenoxymethyl) biphenyl, p-hydroxyacetanilide, p-hydroxybutyranilide, p-hydroxynonananilide, p-hydroxylauranilide, p-hydroxy-octadecananilide, and N-phenyl-phenylsulphonamide.

The above sensitisers are known or can be prepared according to known methods.

In addition, the heat sensitive recording material of the invention can contain a stabiliser. The weight ratio of stabiliser: colour former is usually chosen in the range of from 0:1 to 2:1.

Therefore, a further preferred embodiment of the present invention relates to a heat sensitive recording material consisting essentially of
a) a substrate sheet, and
b) a heat sensitive colored image-forming layer formed on the surface of the substrate sheet and consisting essentially of
   b1) a colour former compound
   b2) the inventive mixture of colour developers,
   b3) a stabilizer and/or a sensitizer.

Representative stabilisers for use in heat sensitive recording materials include 2,2′-methylene-bis(4-methyl-6-tert-butylphenol), 2,2′-methylene-bis(4-ethyl-6-tert-butylphenol), 4,4′-butylidene-bis(3-methyl-6-tert-butylphenol), 4,4′-thio-bis(2-tert-butyl-5-methylphenol), 1,1,3-tris(2-methyl-4-hydroxy-5-tert-butylphenyl) butane, 1,1,3-tris(2-methyl-4-hydroxy-5-cyclohexylphenyl) butane, bis (3-tert-butyl-4-hydroxy-6-methylphenyl) sulfone, bis (3,5-dibromo-4-hydroxyphenyl) sulfone, 4,4′-sulfinyl bis (2-tert-butyl-5-methylphenol), 2,2′-methylene bis (4,6-di-tert-butyl-phenyl) phosphate and alkali metal, ammonium and polyvalent metal salts thereof, 4-benzyloxy-4′-(2-methylglycidyloxy) diphenyl sulfone, 4,4′-diglycidyloxydiphenyl sulfone, 1,4-diglycidyloxybenzene, 4-[α-(hydroxymethyl)benzyloxy]-4-hydroxy-diphenyl sulfone, metal salts of p-nitrobenzoic acid, metal salts of phthalic acid monobenzyl ester, metal salts of cinnamic acid and mixtures thereof.

Preferred stabilisers are 4,4′-butylidene-bis(3-methyl-6-tert-butylphenol), 4,4′-thio-bis(2-tert-butyl-S-methylphenol), 1,1,3-tris(2-methyl-4-hydroxy-5-tert-butylphenyl) butane, 1,1,3-tris(2-methyl-4-hydroxy-5-cyclohexylphenyl) butane, 4-benzyloxy-4′-(2-methylglycidyloxy) diphenyl sulfone and mixtures thereof.

Further preferred stabilizers are the following, which preferably can be used in amounts of less than 5% by weight, based on the total weight of the heat sensitive recording material:
N-(p-toluenesulphonyl)-N′-phenylurea, N-(p-toluenesulphonyl)-N′-(o-tolyl)urea, N-(p-toluenesulphonyl)-N′-(m-tolyl)urea, N-(p-toluenesulphonyl)-N′-(p-tolyl)urea, N-(p-toluenesulphonyl)-N′-(p-n-butylphenyl)urea, N-(p-toluenesulphonyl)-N′-(o-chlorophenyl)urea, N-(p-toluenesulphonyl)-N′-(m-chlorophenyl)urea, N-(p-toluenesulphonyl)-N′-(2,4-dichlorophenyl)urea, N-(p-toluenesulphonyl)-N′-benzylurea, N-(p-toluenesulphonyl)-N′-(1-naphthyl)urea, N-(p-toluenesulphonyl)-N′-[1-(2-methylnaphthyl)]urea, N-(p-toluenesulphonyl)-N′-(o-diphenyl)urea, N-(p-toluenesulphonyl)-N′-butylurea, N-(benzenesulphonyl)-N′-phenylurea, N-(p-chlorobenzenesulphonyl)-N′-phenylurea, N-(o-toluenesulphonyl)-N′-phenylurea, N-(p-toluenesulphonyl)-N′-methylurea, N-(p-toluenesulphonyl)-N′-ethylurea, N,N′-bis(p-toluenesulphonyl)urea, N-benzylsulphonyl-N′-phenylurea, N-(2-phenoxyethane)sulphonyl-N′-phenylurea, N-(4-methoxybenzyl)sulphonyl-N′-phenylurea, N-(2-(p-chlorophenyl)-ethane)sulphony]-N′-phenylurea, N-(p-biphenyl)sulphony]-N′-butylurea, N-benzylsulphonyl-N′-benzylurea, N-benzylsulphony]-N′-phenylthiourea, N-ethanesulphonyl-N′-1-naphthylurea, N-cyclohexanesulphonyl-N′-phenylurea, N-allylsulphonyl-N′-1-naphthylurea, N-(2-methoxy-ethanesulphonyl)-N′-biphenylurea, N-(2-tetrahydropyransulphonyl)-N′-1 naphthylurea, N-(2-allyloxyethanesulphonyl)-N′-1-naphthylurea, N-isopropane-sulphonyl-N′-benzylurea, N-isopropanesulphonyl-N′-(4-methylbenzyl)urea, N-methanesulphonyl-N′-(4-chloro-1-naphthyl)urea, N-isopropanesulphonyl-N′-(4-chloro-1-naphthyl)urea, N-methanesulphonyl-N′-1-naphthyl-thiourea, N-(p-toluene-sulphonyl)-N′-(p-methoxyphenyl)urea, N-(p-toluenesulphonyl)-N′-(m-hydroxy-phenyl)urea, N-(p-toluenesulphonyl)-N′-(p-hydroxyphenyl)urea, N-(p-toluenesul-phonyl)-N′-(p-ethoxycarbonylphenyl)urea, N-(p-toluenesulphonyl)-N′-(2-phenoxy-ethyl)urea, N-benzylsulphonyl-N′-(2-phenoxyethyl)urea, N-benzylsulphonyl-N′-(p-methoxyphenyl)urea, N-(p-methoxybenzyl)sulphony]-N′-(2-(p-chlorophenyl-oxy)ethyl)urea, N-methanesulphonyl-N′-(2-phenoxyethyl)urea, N-methanesulphonyl-N′-(4-methoxy-1-naphthyl)urea, N-(p-toluenesulphonyl)-N′-(3-n-butylaminosulphonylphenyl)urea, N-(p-toluenesulphonyl)-N′-(4-trimethylacetophenyl)urea, N-(benzenesulphonyl)-N′-(3-p-toluenesulphonyloxyphenyl)urea, N-(p-toluene-sulphonyl)-N′-(3-p-toluenesulphonyloxyphenyl)urea, N-(p-toluenesulphonyl)-N′-(3-phenylsulphonyl-oxyphenyl)urea, N-(p-toluenesulphonyl)-N′-(2-p-toluenesulphonyl-oxyphenyl)urea, N-(p-toluenesulphonyl)-N′-(2-phenylsulphonyloxyphenyl)urea, N-(p-toluenesulphonyl)-N′-(4-benzoyloxyphenyl)urea, N-(p-toluenesul phonyl)-N′-(4-phenylsulphonyloxyphenyl)urea, N-(p-toluenesulphonyl)-N′-(4-acetoxyphenyl)urea, N-(p-toluenesulphonyl)-N′-(2-p-toluenesulphonyloxy-5-ethylsulphonyl phenyl)urea, N-(o-toluenesulphonyl)-N′-(3-p-toluenesulphonyloxyphenyl)urea, N-(4-chlorobenzenesulphonyl)-N′-(3-p-toluene-sulphonyloxyphenyl)urea, N-(p-toluenesulphonyl)-N′-(4-p-toluenesulphonyloxyphenyl)urea, N-(p-toluenesulphonyl)-N′-(3-butylsulphonyloxyphenyl)urea, N-(p-toluenesulphonyl)-N′-(2-methyl-4-p-toluenesulphonyloxyphenyl)urea, N-(p-toluenesulphonyl)-N′-(5-p-toluene-sulphonyloxynapthyl)urea, N-(p-toluenesulphonyl)-N′-(4-p-tolyloxysulphonylphenyl)urea, N-(p-toluenesulphonyl)-N′-(3-octylsulphonyloxyphenyl)urea, N-(p-toluenesulphonyl)-N′-(3-Hexadecylsulphonyloxyphenyl)urea, N-(octylsulphonyl)-N′-(3-p-toluenesulphonyl-oxyphenyl)urea, N-(p-toluenesulphonyl)-N′-(4-phenylsulphonyloxyphenyl)urea, N-(phenylsulphonyl)-N′-(3-(p-toluenesulphonyloxy)phenyl)urea, N-(4-chlorophenyl-sulphonyl)-N′-(3-trimethylacetoxyphenyl)urea, N-(p-toluenesulphonyl)-N′-(4-(p-toluenesulphonyloxy)-phenyl)urea, N-(p-toluenesulphonyl)-N′-(4-acetophenyl)urea, N-(p-toluenesulphonyl)-N′-(4-acetamidosulphonylphenyl)urea, N-(p-toluenesulphonyl)-N′-(3-(ethoxycarbonyloxy)phenyl)-urea, N-(p-toluenesulphonyl)-N′-(3-(ethoxycarbamyl)phenyl)urea, N-(p-toluenesulphonyl)-N′-(3-(2-napthyl sulphonyl-oxy)phenyl)urea, N-(p-toluenesulphonyl)-N′-(4-benzoylphenyl)-urea, N-(p-toluenesulphonyl)-N′-(3-(4-toluenesulphonylamino)phenyl)urea, N-(p-toluene-sulphonyl)-N′-(3-acetaminophenyl)urea, N-(4-chlorophenylsulphonyl)-N′-(4-tri-methylacetamidophenyl)urea, N-(benzenesulphonyl)-N′-(4-trimethylacetamido-phenyl)-urea, N-(4-chlorophenylsulphonyl)-N′-(2-(p-toluenesulphonyloxy)-phenyl)urea, N-(p-toluenesulphonyl)-N′-(3-(N,N-di-p-toluenesulphonyl)amino-pheny)urea, N-(benzene-sulphonyl)-N′-(2-(p-toluenesulphonyloxy)phenyl)urea, N-(4-chlorophenylsulphonyl)-N′-(4-acetamidosulphonylphenyl)urea, N-(p-toluene-sulphonyl)-N′-(3-(diphenylphosphinyl)phenyl)-urea; bis(p-methoxybenzenesulphonylaminocarbonylamino)ketone, 1,2-bis(p-methoxy-benzene-sulphonylaminocarbonylamino)ethane, 1,5-bis(p-methoxybenzene-sulphonylamino-carbonylamino)-3-oxapentane, 1,3-bis(p-methoxybenzenesul-phonylaminocarbonylamino)-2-propane, 1,5-bis(p-methoxybenzenesulphonyl-aminocarbonylamino)-3-(2-(p-methoxy-benzenesulfonylaminocarbonylamino)ethyl)-3-azapentane, 1,3-bis(p-methoxybenzene-sulphonylaminocarbonylamino-methyl)benzene, 4,4′-bis(p-methoxybenzenesulphonylamino-carbonylamino) diphenylmethane, 4,4′-bis(p-methoxybenzenesulphonylaminothio-carbonylamino), diphenylmethane, 4,4′-bis(p-nitrobenzenesulphonylaminocarbonylamino)diphenyl-methane, 4,4′-bis(m-trifluoromethylmethoxybenzenesulphonylaminocarbonyl-amino)diphenylmethane, 4,4′-bis(p-phenoxybenzenesulphonylaminocarbonylamino)-diphenylmethane, 4,4′-bis(p-benzyloxybenzenesulphonyl aminocarbonyl-amino)diphenyl-methane, 4,4′-bis(p-acetylbenzenesulphonyl aminocarbonylamino)-diphenylmethane, 4,4′-bis(p-benzoylbenzenesulphonyl aminocarbonylamino)-diphenylmethane, 4,4′-bis(p-allyloxybenzenesulphonyl aminocarbonylamino)-diphenylmethane, 4,4′-bis(p-allyl-benzenesulphonyl aminocarbonylamino)-diphenylmethane, 4,4′-bis(p-ethyny-benzene-sulphonyl aminocarbonylamino)di-phenylmethane, 4,4′-bis(p-cyclohexylbenzene sulphonylaminocarbonylamino)-diphenylmethane, 4,4′-bis(p-phenylbenzenesulphonylamino-carbonylamino)di-phenylmethane, 4,4′-bis(p-benzylbenzenesulphonylaminocarbonylamino)-diphenylmethane, 4,4′-bis(o-methoxybenzenesulphonylaminocarbonylamino) diphenylmethane, 4,4′-bis(p-ethoxybenzenesulphonylaminothiocarbonylamino)-diphenylmethane, 2,2-bis(4′-(p-methoxybenzenesulphonylaminocarbonylamino)-phenyl)propane, 1,2-bis(4′-(p-ethoxybenzenesulphonylaminocarbonylamino)-phenyloxy)ethane, 3,3′-bis(p-methoxybenzenesulphonylaminocarbonylamino)-diphenylsulphone, 4,4′-bis(p-methoxybenzenesulphonylaminocarbonylamino)-diphenylether, 2,5-bis(p-methoxybenzenesulphonylaminocarbonylaminomethyl)-furan, 1,3-bis(p-methoxybenzenesulphonylaminocarbonylamino)benzene, 1,5-bis(p-ethoxybonzene-toluenesulphonylaminocarbonylamino)naphthalene, bis(p-toluene-sulphonylamino-carbonyamino)ketone, 1,2-bis(p-toluenesulphonylaminocarbonyl-amino)ethane, 1,1,6,6-tetra(p-toluenesulphonylaminocarbonylamino)heptane, 1,5-bis(p-toluenesulphonyl-aminocarbonylamino)-3-oxapentane, 1,5-bis(p-toluene-sulphonylaminocarbonylamino)-3-thiopentane, 1,3-bis(p-toluenesulphonyl-aminocarbonylamino)-2-propanone, 1,5-bis(p-toluenesulphonylaminocarbony-lamino)3-[2′(p-toluenesulphonylaminocarbonyl-amino)ethyl]-3-azapentane, 1,3-bis(p-toluenesulphonylaminocarbonylamino)methylbenzene, 1,4-bis(p-toluene-sulphonylaminocarbonylamino)methylbenzene, 4,4′-bis(p-toluenesulphonylamino-carbonylamino)diphenylmethane, 4,4′-bis(o-toluenesulphonylaminocarbonylamino)}-diphenylmethane, 4,4′-bis(benzenesulphonylamniocarbonylamino)-diphenyl-methane, 4,4′-bis(1-naphthalenesulphonylaminocarbonylamino)-diphenylmethane, 2,2-bis[4′-(p-toluenesulphonylaminocarbonylamino)phenyl]propane, 1,2-bis[4′-(p-toluenesulphonyl-aminocarbonylamino)phenyloxy]ethane, 1,4-bis[3′-(p-toluenesulphonylaminocarbonyl-amino)phenyloxy]ethane, 2,5-bis(p-toluenesulphonyl-aminocarbonylamino)methylfuran, 1,3-bis(p-toluenesulphonylaminocarbonyl-amino)benzene, 1,4-bis(p-toluenesulphonylamino-carbonylamino)benzene, 1,5-bis(p-toluenesulphonylaminocarbonylamino)naphthalene, 1,8-bis(p-toluene-sulphonylaminocarbonylamino)naphthalene, 4,4′-bis(p-toluenesulphonylaminocarbonylamino)diphenylether, 3,3′-bis(p-toluenesulphonylaminocarbonyl-amino)-diphenylsulphone, 4,4′-bis(p-toluenesulphonylaminocarbonyl-amino)diphenyl-sulphone, 2,4-bis(p-toluenesulphonylaminocarbonylamino)toluene, 2,6-bis(p-toluenesulphonylamino-carbonylamino)toluene, 4,4′-bis(p-toluenesulphonylamino-carbonylamino)diphenylsulphide, 3,4′-bis(p-toluenesulphonylaminocarbonyl-amino)diphenylether, 4,4-bis(methanesulphonyl-aminocarbonylamino)diphenylmethane, 4,4′-bis(ethanesulphonylaminocarbonylamino)-diphenylmethane, 4,4′-bis(isopropanesulphonylaminocarbonylamino)diphenylmethane, 4,4′-bis(trifluoromethanesulphonylaminocarbonylamino)diphenylmethane, 4,4′-bis(cyclo-hexanesulphonylaminocarbonylamino)diphenylmethane, 4,4′-bis(allyl-sulphonylamino-carbonylamino)diphenylmethane, 4,4′-bis(2-methoxyethane-sulphonylaminocarbonyl-amino)diphenylmethane, 4,4′-bis(2-tetrahydropyran-sulphonylaminocarbonylamino)-diphenylmethane, 4,4′-bis(2-allyloxyethane-sulphonylaminocarbonylamino)diphenylmethane, 1,5-bis(methanesulphonyl-aminocarbonylamino)naphthalene, 1,3-bis(methanesulphonyl-aminocarbonylamino)benzene, 4,4′-bis(methanesulphonylaminocarbonylamino)-diphenylether, 4,4′-bis(methanesulphonylaminothiocarbonylamino) diphenylmethane, 4,4′-bis(benzylsulphonylaminocarbonylamino)diphenylmethane, 4,4′-bis(p-methylbenzyl-sulphonylaminocarbonylamino)diphenylmethane, 4,4′-bis(p-methoxybenzylsulphonyl-aminocarbonylamino)diphenylmethane, 4,4′-bis(p-chlorobenzylsulphonylaminocarbonyl-amino)diphenylmethane, 4,4′-bis(2-phenoxyethylsulphonylaminocarbonylamino)-diphenylmethane, 4,4′-bis(2-(p-methoxyphenoxy)ethylsulphonylaminocarbonylamino) diphenylmethane, 4,4′-bis(benzylsulphonylaminocarbonylamino) diphenylether, 1,5-bis(benzylsulphonyl-aminocarbonylamino)naphthalene, 1,3-bis(benzylsulphonylamino-carbonylamino)-benzene, 4,4′-bis(benzylsulphonylaminothiocarbonylamino)-diphenylmethane, 1,3-bis(p-toluenesulphonylaminocarbonylamino)-2-methylbenzene, 1,4-bis(p-toluene-sulphonylaminoca rbonylamino)-2,5-dimethylbenzene, 4,4′-bis(p-toluenesulphonyl-aminocarbonylamino)-3,3′-dimethyldiphenylmethane, 4,4′-bis(p-toluenesulphonyl-aminothiocarbonyl amino)-3,3′-dimethyldiphenylmethane, 4,4′-bis(o-toluenesul-phonylamino carbonylamino)-3,3′-dimethyidiphenylmethane, 4,4′-bis(benzene-sulphonyl aminocarbonylamino)-3,3′-dimethyidiphenylmethane, 4,4′-bis(p-toluene-sulphonylaminocarbonylamino)-3,3′-diethyldiphenylmethane, 4,4′-bis(p-toluene-sulphonyl-aminocarbonylamino)-3,3′-dichloro diphenylmethane, 4,4′-bis(p-toluene-sulphonyl-aminocarbonylamino)-3,3′,5,5′-tetramethyldiphenylmethane, 4,4′-bis(p-toluenesulphonyl-aminocarbonyl amino)-3,3′,5,5′-tetraethyidiphenyl-methane, 4,4′-bis(p-toluenesulphonyl aminocarbonylamino)-3,3′-dimethoxylbiphenyl, 4,4′-bis(p-toluenesulphonylaminocarbonyl-amino)-3,3′-dimethylbiphenyl, 4,4′-bis(p-toluenesulphonylaminocarbonylamino)-2,2′,5,5′-tetrachlorobiphenyl, 2,8-dimethyl-3,7-bis(p-toluenesulphonylaminocarbonylamino)dibenzothiophene-5,5-dioxide, 4,4′-bis(p-toluenesulphonylaminocarbonylamino)-3,3′-dimethyldiphenylether, 2,5-bis(p-toluenesulphonylaminocarbonylaminomethyl)-3,5-diethylfuran; N-(p-toluenesulphonyl)-N′-(pyrid-3-yl)urea, N-(p-toluenesulphonyl)-N′-(6-methylpyridin-2-yl)urea, N-(p-toluenesulphonyl)-N′-(5-methylisoxazol-3-yl)urea, N-(p-toluenesulphonyl)-N′-((1,2-dihydro-1,5-dimethyl-2-phenyl-3H-pyrazyol-3-one)4-yl)urea, N-(p-toluenesulphonyl)-N′-(1.H.-indazol-6-yl)urea, N-(p-toluenesulphonyl)-N′-(4,6-dimethylpyrimidin-2-yl)urea, N-(p-toluenesulphonyl)-N′-(benzothiazol-2-yl)urea, N-(p-toluenesulphonyl)-N′-(thiazol-2yl)urea, N-(p-toluenesulphonyl)-N′-(5-methyl-1.H.-pyrazol-3-yl)urea, N-(p-toluenesulphonyl)-N′-(benzimidazol-2-yl)urea, N-(p-toluenesulphonyl)-N′-(pyrimidin-2-yl)urea, N-(p-toluene-sulphonyl)-N′-(6-methanesulphonylbenzothiazol-2-yl)urea, N-(p-toluenesulphonyl)-N′-[4-(6-methyl-benzothiazol-2yl)phenyl]urea, N-(p-toluenesulphonyl)-N′-(1.H.-[1,2,4]triazol-3-yl)-urea.

All the exemplified stabilisers can be used singly or as a mixture with other stabilisers.

The heat sensitive recording material of the invention can be prepared according to conventional methods. For example, at least one colour forming compound, at least one developer and, if desired, at least one sensitiser are ground separately in water or a suitable dispersing medium, such as aqueous polyvinyl alcohol, to form an aqueous or other dispersion. If desired a stabiliser is treated in the same manner. The fine particle dispersions thus obtained generally are combined and then mixed with conventional amounts of binder, filler and lubricant. Usually the binder is used in a weight ratio in the range of from 0.5:1 to 4:1, preferably 3.5:1. The amount of filler and lubricant usually depends from the end application and as a rule is chosen by the manufacturer of the heat sensitive recording material in amounts well known to the person skilled in the art.

Representative binders used for the heat sensitive recording material include for example polyvinyl alcohol (fully and partially hydrolysed), carboxy, amide, sulfonic and butyral modified polyvinyl alcohols, derivatives of cellulose such as hydroxyethyl cellulose, methyl cellulose, ethyl cellulose, carboxymethyl cellulose and acetyl cellulose, copolymer of styrene-maleic anhydride, copolymer of styrene-butadiene, polyvinyl chloride, polyvinyl acetate, polyacrylamide, polyamide resin and mixtures thereof.

Exemplary fillers, which can be used, include e.g. calcium carbonate, kaolin, calcined kaolin, aluminium hydroxide, talc, titanium dioxide, zinc oxide, silica, polystyrene resin, urea-formaldehyde resin, hollow plastic pigment and mixtures thereof.

Representative lubricants for use in heat sensitive recording materials include e.g. dispersions or emulsions of stearamide, methylene bisstearamide, polyethylene, carnauba wax, paraffin wax, zinc stearate or calcium stearate and mixtures thereof. Other additives can also be employed, if necessary. Such additives are for example fluorescent whitening agents and ultraviolet absorbers.

The coating composition so obtained can be applied to a suitable substrate such as paper, plastic sheet and resin coated paper, and used as the heat sensitive recording material. The system of the invention can be employed for other end use applications using colour forming materials, for example, a temperature indicating material, sterilisation indicating material.

The quantity of the coating is usually in the range of 2 to 10 g/m², most often in the range 4 to 8 g/m².

The recording material containing such a thermosensitive colouring layer can in addition contain a protective layer and, if desired, an undercoat layer. The undercoat layer may be interposed between the substrate and the thermosensitive colouring layer.

The protective layer usually comprises a water-soluble resin in order to protect the thermosensitive colouring layer. If desired, the protective layer may contain water-soluble resins in combination with water-insoluble resins.

As such resins conventional resins can be employed. Specific examples are: polyvinyl alcohol; starch and starch derivatives; cellulose derivatives such as methoxycellulose, hydroxyethylcellulose, carboxymethylcellulose, methylcellulose and ethylcellulose; sodium polyacrylate; polyvinyl pyrrolidone; polyacrylamide/acrylic acid ester copolymers; acrylamide/acrylic acid ester/methacrylic acid copolymers; alkali metal salts of styrene/maleic anhydride copolymers; alkali metal salts of isobutylene/maleic anhydride copolymers; polyacrylamide; sodium alginate; gelatin; casein; water-soluble polyesters and carboxyl-group-modified polyvinyl alcohols.

The protective layer may also contain a water-resisting agent such as a polyamide resin, melamine resin, formaldehyde, glyoxal or chromium alum.

Furthermore, the protective layer may contain fillers, such as finely-divided inorganic powders, e.g. of calcium carbonate, silica, zinc oxide, titanium oxide, aluminium hydroxide, zinc hydroxide, barium sulphate, clay, talc, surface-treated calcium or silica, or a finely-divided organic powder of, e.g., a urea-formaldehyde resin, a styrene/methacrylic acid copolymer or polystyrene.

The undercoat layer usually contains as its main components a binder resin and a filler.

Specific examples of binder resins for use in the undercoat layer are: polyvinyl alcohol; starch and starch derivatives; cellulose derivatives such asmethoxycellulose, hydroxyethylcellulose, carboxymethylcellulose, methylcellulose and ethylcellulose; sodium polyacrylate; polyvinyl pyrrolidone; polyacrylamide/acrylic acid ester copolymers; acrylamide/acrylic acid ester/methacrylic acid copolymers; alkali metal salts of styrene/maleic anhydride copolymers; alkali metal salts of isobutylene/maleic anhydride copolymers; polyacrylamide; sodium alginate; gelatin; casein; water-soluble polymers such as water-soluble polyesters and carboxyl-group-modified polyvinyl alcohols; polyvinyl acetate; polyurethanes; styrene/butadiene copolymers; polyacrylic acid; polyacrylic acid esters; vinyl chloride/vinyl acetate copolymers; polybutylmethacrylate; ethylen/vinylacetate copolymers and styrene/butadiene acrylic derivative copolymers.

Specific examples of fillers for use in the undercoat layer are: finely-divided inorganic powders, e.g. of calcium carbonate, silica, zinc oxide, titanium oxide, aluminium hydroxide, zinc hydroxide, barium sulphate, clay, talc, surface-treated calcium, silica or calcined clay (e.g. Ansilex,Engelhard Corp.), and finely-divided organic powders of, e.g., urea-formaldehyde resins, styrene/methacrylic acid copolymers and polystyrene.

In addition, the undercoat layer may contain a water-resisting agent. Examples of such agents are given above.

In particular the invention provides exceptional resistance to plasticiser, oil and heat ageing whilst showing improved background whiteness, in particular after ageing at elevated temperature in a humid atmosphere.

### EXAMPLES

### Example 1

### Preparation of Heat Sensitive Coating Formulations Containing N-(p-toluenesulphonyl)-N′-(3-p-toluenesulphonyloxyphenyl) Urea and p-toluenesulphonylurea (99:1)

Dispersions A to C are prepared by grinding the compositions shown below in an attritor until an average particle size of 1 to 1.5 μm is attained.

| Dispersion A (Colour Former) | | |
|---|---|---|
| 3-dibutylamino-6-methyl-7-anilinofluoran | 3.01 | parts |
| Polyvinyl alcohol (10% aqueous solution) | 10.50 | parts |
| Water | 6.49 | parts |

| Dispersion B (Colour Developer) | | |
|---|---|---|
| N-(p-toluenesulphonyl)-N′-(3-p- | 7.5 | parts |
| toluenesulphonyloxyphenyl)urea:p- | | |
| toluenesulphonylurea. (99:1) | | |
| Polyvinyl alcohol (10% aqueous solution) | 7.5 | parts |
| Water | 22.5 | parts |

| Dispersion C (Sensitiser) | |
|---|---|
| parabenzylbiphenyl | 10.0 parts |
| Polyvinyl alcohol (10% aqueous solution) | 10.0 parts |
| Water | 20.0 parts |

A thermal coating mixture is then prepared by combining together the following components:

| | parts by weight |
|---|---|
| Dispersion A | 6.6 |
| Dispersion B | 12.5 |
| Dispersion C | 6.0 |
| Calcium Carbonate (25% aqueous dispersion) | 13.2 |
| Zinc stearate (33% aqueous dispersion) | 1.5 |
| Polyvinyl alcohol (10% aqueous solution) | 6.5 |
| Tinopal ® ABP-X (fluorescent whitening agent) | 0.12 |
| Water | 10.18 |

This coating mixture is applied on one side of a base paper weighing 50 g/m² in a coating weight of about 5.0 g/m² and then dried. The resulting sheet is calendered by means of a laboratory calender to produce a recording sheet. The sheet so produced is subjected to a number of application tests, described below, the results are summarised in table 1.

### Comparative Example 1

A heat sensitive recording paper is prepared as in Example 1 but using N-(p-toluenesulphonyl)-N′-(3-p-toluenesulphonyloxyphenyl) urea as the sole developer in dispersion B.

The heat sensitive recording paper obtained demonstrates excellent background whiteness of paper after application of the coating liquid and in storage stability, i.e. resistance to ageing of the coated paper and excellent resistance of the image to cottonseed oil and plasticiser.

### Examples 2-11

Heat sensitive recording papers are prepared according to example 1 but using the compositions shown below as the developer in dispersion B.

| Ex. | Developer 1 | wt-% | Developer 2 | wt-% |
|---|---|---|---|---|
| 2 | N-(p-toluenesulphonyl)-N′-(3-p-toluenesulphonyloxyphenyl)urea | 99 | p-toluenesulphonylurea | 5 |
| 3 | N-(p-toluenesulphonyl)-N′-(3-p-toluenesulphonyloxyphenyl)urea | 90 | p-toluenesulphonylurea | 10 |
| 4 | N-(p-toluenesulphonyl)-N′-(3-p-toluenesulphonyloxyphenyl)urea | 85 | p-toluenesulphonylurea | 15 |
| 5 | N-(p-toluenesulphonyl)-N′-(3-p-toluenesulphonyloxyphenyl)urea | 80 | p-toluenesulphonylurea | 20 |
| 6 | N-(p-toluenesulphonyl)-N′-(3-p-toluenesulphonyloxyphenyl)urea | 75 | p-toluenesulphonylurea | 25 |
| 7 | N-(p-toluenesulphonyl)-N′-(3-p-toluenesulphonyloxyphenyl)urea | 50 | p-toluenesulphonylurea | 50 |
| 8 | N-(p-toluenesulphonyl)-N′-(3-p-toluenesulphonyloxyphenyl)urea | 85 | napthylsulphonylurea | 15 |
| 9 | N-(p-toluenesulphonyl)-N′-(3-p-toluenesulphonyloxyphenyl)urea | 85 | phenylsulphonylurea | 15 |
| 10 | N-(p-toluenesulphonyl)-N′-(3-p-toluenesulphonyloxyphenyl)urea | 85 | Hexadecyl sulphonylurea | 15 |

### Description of Test Methods

Background Whiteness Before and After Ageing

This test assesses the effects of heat and moisture on unprinted thermal paper.

The whiteness of unprinted paper is measured using a Macbeth 1200 series Densitometer, before and after ageing for one hour at 60° C. and 50% R.H.

Cottonseed Oil Resistance of Image

This test assesses the stability of the image when exposed to cottonseed oil.

An image is produced using an Atlantek thermal response tester model 200. Cottonseed oil is then Gravure printed onto the image which is then stored at 40° C. for 24 hrs. The optical density of the image is measured using a Macbeth 1200 series Densitometer before and after exposure.

Plasticiser Resistance of Image and Background

This test assesses the stability of the image and background when exposed to PVC containing 20 to 25% by weight of phthalate ester-type plasticiser.

An image is produced using an Atlantek thermal response tester model 200. The image is put into contact with the PVC under 107 g cm⁻² pressure for 6 hours at 50° examples 9-11 this test is extended to 24 hours. The optical density of the image and background are measured using a Macbeth 1200 series Densitometer before and after exposure.

Application Test Results

| | Optical | Background | Background | | | Cottonseed |
|---|---|---|---|---|---|---|
| | density of | whiteness | whiteness | Plastic - | | oil resistance |
| Ex. | initial image | before aging | after aging | Image B/grd | | of image |
| Comp. | 1.3 | 94 | 86 | 1.05¹ | 90² | 1.3 |
| Ex. 1 | | | | | | |
| 1 | = | + | + | + | + | = |
| 2 | = | + | + | + | + | = |
| 3 | = | + | + | + | + | = |
| 4 | = | + | + | + | + | = |
| 5 | = | + | + | + | + | = |
| 6 | = | + | + | + | + | = |
| 7 | = | + | + | + | + | = |
| 8 | − | + | + | = | + | − |
| 9 | = | + | = | + | = | = |
| 10 | = | + | = | + | = | = |
| 11 | = | + | − | + | = | = |

Key
= equal to comparative example 1
+ superior to comparative example 1
− inferior to comparative example 1
¹1.05 = Image density after test
²90 = background whiteness after test

1. Mixture of colour developers comprising a compound of the formula (I) 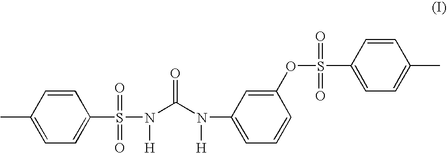
and a compound of formula (II) 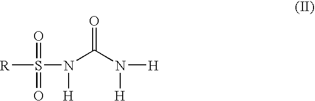
wherein
R¹ is C₁-C₂₀alkyl or C₆-C₁₀aryl, which can be substituted one to three times with halogen, C₁-C₄alkyl, —NR²R³, wherein R² and R³ independently from each other stand for hydrogen or C₁-C₈alkyl, or C₁-C₈acyl amino.

2. Mixture according to claim 2, wherein the weight ratio of the compound of formula (I) to the compound of formula (II) is in the range of from 999:1 to 1:1.

3. Heat sensitive recording material comprising
a) a substrate sheet, and
b) a heat sensitive colored image-forming layer formed on the surface of the substrate sheet and which layer comprises
b1) a colour former compound and
b2) the mixture of colour developers according to claim 1.

4. Heat sensitive recording material according to claim 3 consisting essentially of
a) a substrate sheet, and
b) a heat sensitive colored image-forming layer formed on the surface of the substrate sheet and which layer consists essentially of
b1) a colour former compound,
b2) the mixture of colour developers according to claim 1, and
b3) a stabilizer and/or a sensitizer.

5. (canceled)

6. A method of manufacturing a heat-sensitive recording material comprising
forming the mixture according to claim 1 and
coating the mixture onto a substrate to form a heat-sensitive colored image forming layer.
